(19) United States
(12) Patent Application Publication
(10) Pub. No.: US 2018/0072533 A1
(43) Pub. Date: Mar. 15, 2018

(54) LOCKING MODULE OF WIRE AUTO-WINDING DEVICE

(71) Applicants: BSE Co., Ltd., Incheon (KR); Tianjin BSE Electronics Co., Ltd., TEDA, Tiamjin (CN); Dongguan Baoxing Electronics Co., Ltd., Dongguan City, Guangdong (CN); Rongcheng Baoxing Electronic Co., Ltd., Rongcheng City, Shandong (CN)

(72) Inventors: Kwang Duk PARK, Incheon (KR); Hong Kyu JANG, Seoul (KR)

(73) Assignees: BSE Co., Ltd., Incheon (KR); Tianjin BSE Electronics Co., Ltd., TEDA, Tianjin (CN); Dongguan Baoxing Electronics Co., Ltd., Dongguan City, Guangdong (CN); Rongcheng Baoxing Electronic Co., Ltd., Rongcheng City, Shandong (CN)

(21) Appl. No.: 15/558,913

(22) PCT Filed: Mar. 18, 2016
(86) PCT No.: PCT/KR2016/002754

§ 371 Date: Sep. 15, 2017

(30) Foreign Application Priority Data
Mar. 18, 2015 (KR) 10-2015-0037500

(51) Int. Cl. B65H 75/44; B65H 75/40

(52) U.S. Cl. CPC B65H 75/4431; H04R 1/1033; B65H 2701/36; B65H 75/406

(57) ABSTRACT

A locking module of a wire auto-winding device includes a first case having a coupling projection formed thereon; a rotating piece inserted over the coupling projection of the first case in order to be rotated clockwise or counterclockwise; a button member coupled to the rotating piece and being slid in a first direction to rotate the rotating piece by means of a button operation; a stopper member coupled to the rotating piece to be slid in a second direction by means of the rotation of the rotating piece; a resilient spring for pushing and returning one of the button member or the stopper member in the opposite direction; and a second case fastened to the first case to form a component receiving space therein.

### FIELD OF THE INVENTION

The present invention relates to a wire auto-winding device that is used for an earphone or the like to unwind a wire when used and automatically wind the wire by releasing locking when usage is finished so as to be conveniently carried, and more particularly, to a locking module of a wire auto-winding device, which has an improved performance by virtue of an improved unlocking structure.

### BACKGROUND OF THE INVENTION

In general, when a user watches movies or listens music by using a portable media device, the user connects an earphone to the device for using without place restriction. An earphone conventionally includes an earphone output unit through which sound is outputted and an earphone cable (wire) connected to the earphone output unit to provide an outputted signal generated from the device to the earphone output unit, thereby generating sound.

However, as the earphone cable is manufactured to have an extra length so that the user may use the earphone without inconvenience, the earphone cable may be tangled or twisted when the user does not use the earphone. To solve the above inconvenience, a wire auto-winding device, in which the earphone cable wound around an assistant tool is extended as much as a desired length when the earphone cable is pulled by a desired length and the extended earphone cable is wound around the assistant tool when a switch is pushed, has been developed to be used.

The wire auto-winding module in which a noise is reduced by a push-key is disclosed in Korean Registered Patent No. 10-1401906. Here, the wire auto-winding module having a bar shape includes: a module key having one end engaged with a brake sawtooth and an inclined surface defined on one side surface thereof; a module key bracket having a hollow three-dimensional shape in which a module key is inserted and one surface is opened so that the module key is moved in and out; and a side push key disposed in parallel to a direction perpendicular to the module key and having an extended piece extending in a direction perpendicular to the module key on one of surfaces facing the module key and an inclined surface facing an inclined surface of the module key on one surface of the extended piece, so that performing locking and unlocking operations through contact between the inclined surfaces.

However, in the above wire auto-winding device structure for performing the locking and unlocking operations through the contact of the inclined surface structure, limitations such as mismatching and malfunction may be generated.

### PRIOR ART DOCUMENT

(PATENT DOCUMENT 1) KR10-1401906 B1

### SUMMARY OF THE INVENTION

### Technical Problem

The present invention provides a locking module of a wire auto-winding device, which may adjust a moving distance between a stopper and a button according to a shape of a tooth of a pinion by using a rack and a pinion.

The present invention also provides a locking module of a wire auto-winding device, which may be freely designed by using a cam, a pinion, or a combination thereof in coupling between a stopper and a button.

### Technical Solution

An embodiment of the present invention provides a locking module of a wire auto-winding device including: a first case on which a coupling projection is formed; a rotating piece inserted to the coupling projection of the first case and rotated in a clockwise or counter-clockwise direction; a button member coupled to the rotating piece to rotate the rotating piece while slid in a first direction according to button manipulation; a stopper member coupled to the rotating piece and slid in a second direction according to the rotation of the rotating piece; a resilient spring pushing one of the button member or the stopper member in an opposite direction to return the same to an original position; and a second case coupled to the first case to define a component accommodation space therebetween.

In a first embodiment of the present invention, a locking module of a wire auto-winding device includes: a first case on which a coupling projection is formed; a pinion inserted to the coupling projection of the first case; a button member having a tooth formed on one end thereof to serve as a rack coupled to the pinion and slid in a first direction according to button manipulation to rotate the pinion; a stopper member having a tooth formed on one end thereof to serve as a rack coupled to the pinion and slid in a second direction according to the rotation of he pinion; a resilient spring pushing one of the button member or the stopper member in an opposite direction to return the same to an original position; and a second case coupled to the first case to define a component accommodation space therebetween.

In a second embodiment of the present invention, a locking module of a wire auto-winding device includes: a first case on which a coupling projection is formed; a cam inserted to the coupling projection of the first case; a button member coupled to the cam to rotate the cam while slid in a first direction according to button manipulation; a stopper member coupled to the cam and slid in a second direction according to the rotation of the cam; a resilient spring pushing one of the button member or the stopper member in an opposite direction to return the same to an original position; and a second case coupled to the first case to define a component accommodation space therebetween.

In a third embodiment of the present invention, a locking module of a wire auto-winding device includes: a first case on which a coupling projection is formed; a rotating piece inserted to the coupling projection of the first case and on which a cam and a pinion are formed; a button member coupled to the cam or the pinion of the rotating piece to rotate the rotating piece while slid in a first direction according to button manipulation; a stopper member coupled to the cam or the pinion of the rotating piece and slid in a second direction according to the rotation of the rotating piece; a resilient spring pushing one of the button member or the stopper member in an opposite direction to return the same to an original position; and a second case coupled to the first case to define a component accommodation space therebetween.

In an embodiment, the resilient spring may include: a first resilient spring pushing the button member in the opposite direction to return the same to the original position; and a second resilient spring pushing the stopper member in the opposite direction to return the same to the original position.

In an embodiment, a guide hole for accommodating the button member and a guide hole for accommodating the stopper member may be defined in one of the first case or the second case to have a rail coupling structure for preventing the button member and the stopper member from being escaped.

### Advantageous Effects

According to the present invention, as the operation distance may be freely designed by using the cam, the pinion, and the combination thereof in the coupling between the stopper and the button, and the misalignment may be prevented to suppress the malfunction, and the movement of the button or the noise when the wire is withdrawn may be minimized.

Also, according to the present invention, the shape of the pinion may be modified to differentiate the release stroke form the button stroke, and the slim button structure may be realized.

### BRIEF DESCRIPTION OF THE DRAWINGS

FIG. 1 is a schematic view illustrating an entire configuration of a wire auto-winding device according to the present invention.

FIG. 2 is a view illustrating a locking module of a wire auto-winding device according to a first embodiment of the present invention.

FIG. 3 is an exploded perspective view of the locking module in FIG. 2.

FIG. 4 is a view illustrating an operation state of the locking module according to the first embodiment of the present invention.

FIG. 5 is a schematic view illustrating an example in which the number of springs is changed according to the first embodiment of the present invention.

FIG. 6 is a schematic view illustrating an example in which the number of springs is changed according to the first embodiment of the present invention.

FIG. 7 is a schematic view illustrating a rail coupling structure between a rack and a case according to the first embodiment of the present invention.

FIG. 8 is a view illustrating a locking module of a wire auto-winding device according to a second embodiment of the present invention.

FIG. 9 is an exploded perspective view of the locking module in FIG. 8.

FIG. 10 is a view illustrating a locking module of a wire auto-winding device according to a third embodiment of the present invention.

FIG. 11 is an exploded perspective view of the locking module in FIG. 10.

### DETAILED DESCRIPTION

The present invention and the technical objects achieved by the embodiment of the present invention will be clear by the exemplary embodiments that are described below. Following embodiments give further detailed description to help understanding of the prevent invention, but do not limit the scope of the present invention.

FIG. 1 is a schematic view illustrating an entire configuration of a wire auto-winding device according to the present invention.

As illustrated in FIG. 1, a wire auto-winding device includes: a housing 12; an auto-winding module 14 accommodated in one side of the housing 12 to unwind a wire wound around a retractable rotating plate when the wire is pulled, maintain a current length of the wire by being automatically locked when the wire is released, and automatically wind the wire when the locking is released; a locking plate 16 rotating together with the auto-winding module 14; and a locking module communicated with the locking plate 16 to allow rotation of the auto-winding module 14 in one direction, lock the rotation thereof in the other direction, and allow the rotation thereof in the other direction when a release button is inputted.

Referring to FIG. 1, the auto-winding module 14 includes a retractable rotating plate (not shown) around which the wire is wound and a resilient member (not shown) applying a rotation force to the retractable rotating plate in a direction in which the wire is wound. A brake sawtooth 16a for allowing the rotation in one direction and preventing the rotation in the other direction is provided in plurality on the locking plate 16 disposed on the same axis as that of the retractable rotating plate so as to be rotated together with the same. A stopper 18a of the locking module is pushed along an inclined surface of the brake sawtooth 16a to allow the rotation in one direction, and a catching protrusion of the brake sawtooth 16a is caught by the stopper 18a of the locking module to prevent the rotation in the other direction when rotated in the other direction.

The auto-winding device 10 having the above-described structure may unwind the wound wire when a user pulls the wire in such a manner that the stopper 18a of the locking module is pushed along the inclined surface of the brake sawtooth 16a and the retractable rotating plate is rotated in one direction, and maintain the current length of the wire when the user releases the wire in such a manner that while the locking plate 16 is rotated in an opposite direction by a restoring force of the retractable rotating plate, the brake sawtooth 16a is caught by the stopper 18a of the locking module.

When the user finishes the usage of an earphone and pushes the release button of the locking module 18, the stopper 18a caught by the catching protrusion is pushed backward by an operation of the locking module 18 according to the present invention to release the locking, and accordingly, the retractable rotating plate is rotated in the other direction by the restoring force to automatically wind the wire.

Since the above operation of the wire auto-winding device is well known, further description will be omitted.

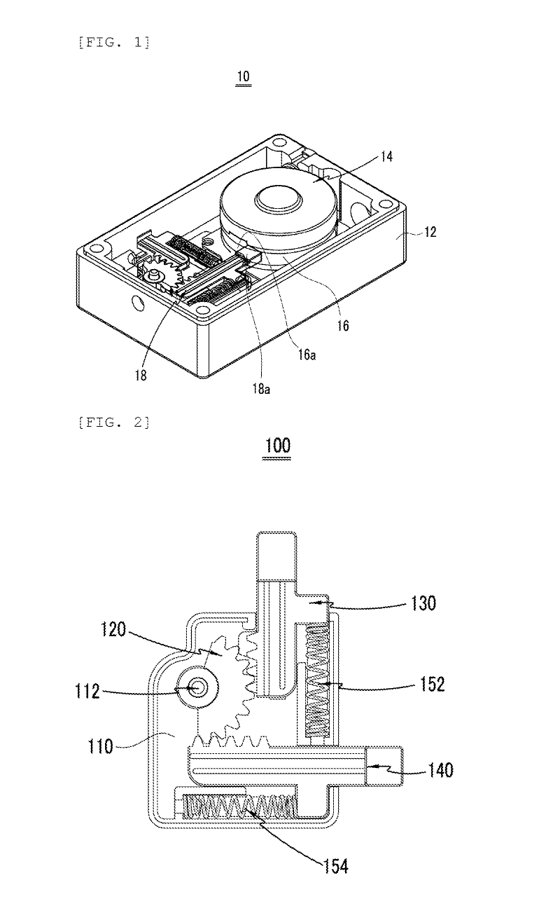

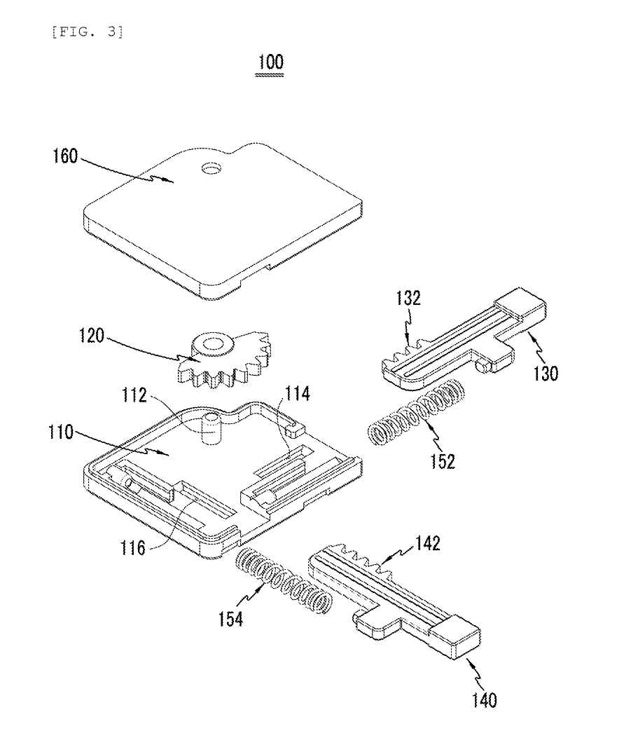

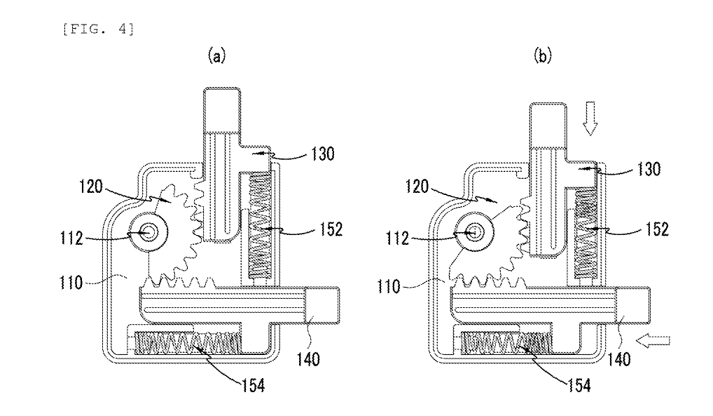

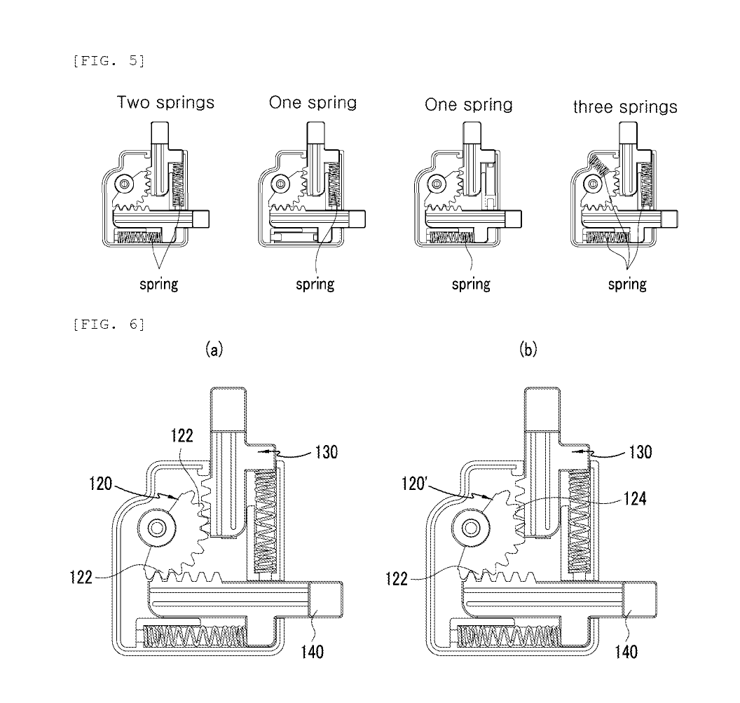

FIG. 2 is a view illustrating a locking module of a wire auto-winding device according to a first embodiment of the present invention, FIG. 3 is an exploded perspective view illustrating a component of the locking module in FIG. 2, and FIG. 4 is a view illustrating an operation state of the locking module device according to the first embodiment of the present invention. FIG. 5 is a schematic view illustrating an example in which the number of springs according to the first embodiment of the present invention is changed, FIG. 6 is a schematic view illustrating an example in which a tooth shape of a pinion gear according to the first embodiment of the present invention is modified, and FIG. 7 is a schematic view illustrating a rail coupling structure between a rack and a case according to the first embodiment of the present invention.

As illustrated in FIGS. 2 and 3, a locking module 100 according to the first embodiment of the present invention includes a case 110, a pinion 120, a button rack 130, a stopper rack 140, resilient springs 152 and 154, and a top case 160.

Referring to FIGS. 2 and 3, a coupling projection 112 serving as a rotational shaft of the pinion, a guide hole 114 for accommodating the button rack 140, and a guide hole 116 for accommodating the stopper rack are formed on a bottom case 110. The top case 160 and the bottom case 110 are coupled to each other to define a component accommodation space therebetween.

The pinion 120 that is a partial piece in which a tooth is formed on a circumferential surface is inserted to the coupling projection 112, so that one side thereof is coupled to the button rack 130 and the other side is coupled to the stopper rack 140, thereby transferring an operation of the button rack 130 to the stopper rack 140. As illustrated in FIG. 6, as the tooth of the pinion 120 is modified, a moving distance of the button rack 130 and a moving distance of the stopper rack 140 may be different. Referring to FIG. 6, FIG. 6A illustrates a case in which the button rack 130 and the stopper rack 140 have the same moving distance because a tooth 122 of the pinion 120 is uniform, and FIG. 6B illustrates a case in which the moving distances are different because the tooth 124 of the pinion 120 at a portion contacting the button rack and the tooth 122 of the pinion 120 at a portion contacting the stopper rack are different. Referring to FIG. 6B, since the tooth 124 of the portion coupled to the button rack 130 and the tooth 122 of the portion coupled to the stopper rack 140 are different in a modified pinion 120′, the moving distances of the button rack 130 and the stopper rack 140 are different.

As the bar-shaped button rack 130 has one end on which the tooth 132 is formed to serve as a rack coupled to the pinion 120, the button rack 130 is slid in a first direction (vertical direction) according to button manipulation to rotate the pinion 120, and as the stopper rack 140 has one end on which the tooth 142 is formed to serve as a rack coupled to the pinion 120, the stopper rack 140 is slid in a second direction (left and right direction) in accordance with rotation of the pinion 120 and caught by the catching protrusion of the brake sawtooth 16a to control the rotation of the auto-winding module 14.

Also, the resilient springs 152 and 154 for providing a restoring force are coupled to the button rack 130 or the stopper rack 140 to return the same to an original position when the button rack 130 is released after a push manipulation. As illustrated in FIG. 5, one to three the resilient springs may be installed to adjust the restoring force.

As illustrated in FIG. 7, the button rack 130 or the stopper rack 140 has a rail coupling structure through the guide holes 114 and 116 of the bottom case to prevent the button rack 130 or the stopper rack 140 from being escaped.

As illustrated in FIG. 4A, as the button rack 130 and the stopper rack 140 are in a protruding state by the resilient force of the springs 152 and 154, the locking module 100 having the above-described configuration according to the first embodiment of the present invention maintains a locking state (initial state) in which a head portion of the stopper rack 140 is caught by the catching protrusion of the brake sawtooth 16a to suppress the rotation of the auto-winding module 14.

As illustrated in FIG. 4B, when the user pushes the button to release the locking, the button rack 130 moves inward to rotate the pinion 120 in a clockwise direction, and accordingly, the stopper rack 140 moves inside the case to release the locking of the auto-winding module 13. As the locking is released, the retractable rotating plate is rotated in the other direction by the restoring force to automatically wind the wire.

Thereafter, when the user releases the button, the button rack 130 moves outward by the restoring force of the resilient springs 152 and 154, and accordingly, the pinion 120 is rotated in a counter-clockwise direction to push the stopper rack 140 to the outside again, and the head portion of the stopper rack 140 is caught by the catching protrusion of the braking saw tooth 16a to lock the rotation of the auto-winding module 14.

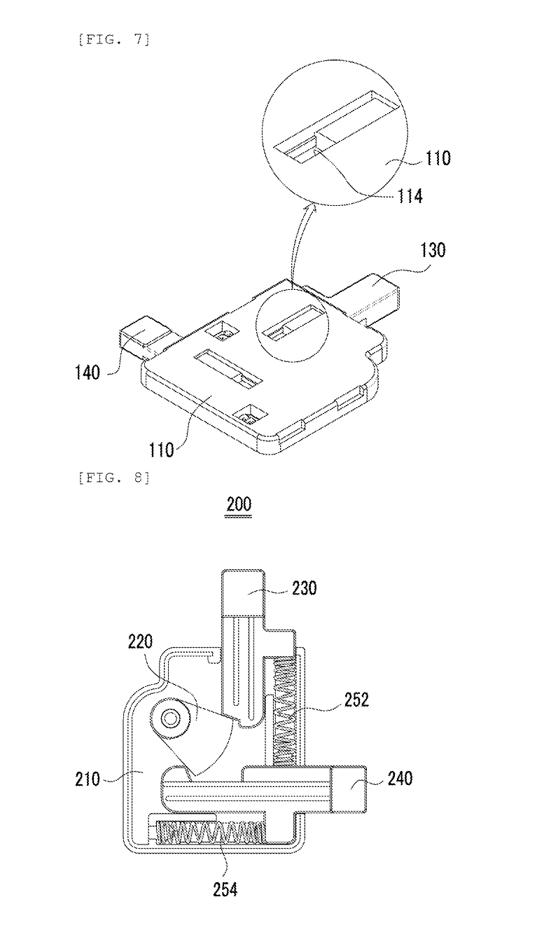

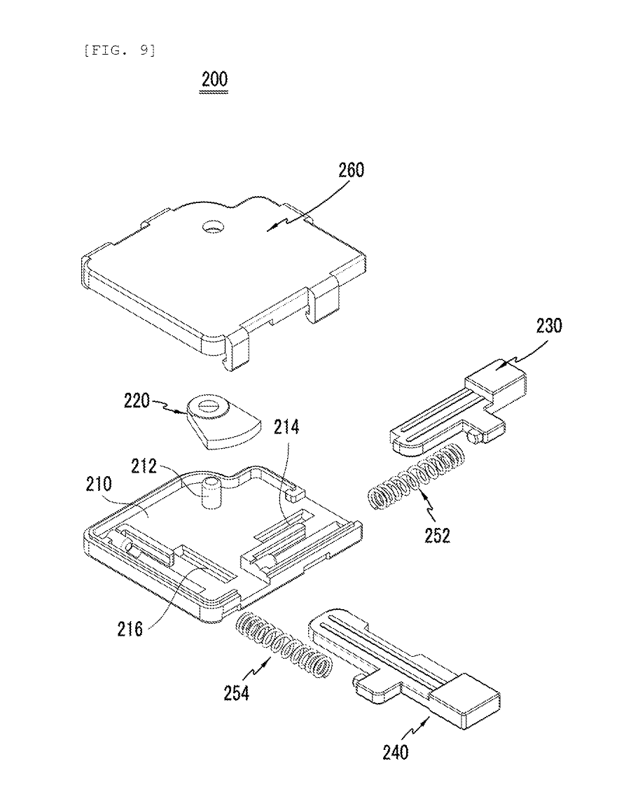

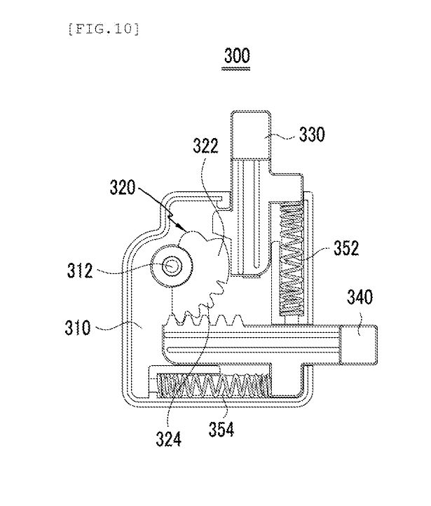

FIG. 8 is a view illustrating a locking module according to a second embodiment of the present invention, and FIG. 9 is an exploded perspective view illustrating a component of the locking module in FIG. 8.

As illustrated in FIGS. 8 and 9, a locking module 200 according to the second embodiment of the present invention includes a bottom case 210, a cam 220, a button member 230, a stopper member 240, resilient springs 252 and 254, and a top case 260.

Referring to FIGS. 8 and 9, a coupling projection 212 serving as a rotational shaft of the cam 220, a guide hole 214 for accommodating the button member 230, and a guide hole 216 for accommodating the stopper member are provided on a bottom case 210. The top case 260 and the bottom case 210 are coupled to each other to define a component accommodation space therebetween.

The cam 220 that is a partial rotating piece without a tooth is inserted to the coupling projection 212 of the bottom case. The cam 220 has one side coupled to the button member 230 and the other side coupled to the stopper member 240 to transmit a movement of the button member 230 to the stopper member 240.

As a coupling portion for being coupled to the cam 220 is provided on one end of the button member 230, the bar-shaped button member 230 is slid in a first direction (vertical direction) to rotate the cam 220 according to button manipulation. As a coupling stepped portion is provided on one end of the stopper member 240, the stopper member 240 is slid in a second direction (left and right direction) according to the rotation of the cam 220 and caught by the catching protrusion of the brake sawtooth 16a to control the rotation of the auto-winding module 14.

Also, the resilient springs 252 and 254 for providing a restoring force are coupled to the button member 230 or the stopper member 240 to return the same to an original position when the button member 230 is released after a push manipulation of the button member 230. As illustrated in FIG. 5, one to three the resilient springs may be installed to adjust the restoring force.

As illustrated in FIG. 7, the button member 230 or the stopper member 240 has a rail coupling structure through the guide holes 214 and 216 of the bottom case to prevent the button member 230 or the stopper member 240 from being escaped.

As the button member 230 and the stopper member 240 are in a protruding state by the resilient force of the springs 152 and 154 when the button is released, the locking module 200 having the above-described configuration according to the second embodiment of the present invention maintains a locking state in which a head portion of the stopper member 240 is caught by the catching protrusion of the brake sawtooth 16a to prevent the rotation of the auto-winding module 14.

As illustrated in FIG. 4B, when the user pushes the button to release the locking, the button member 230 moves inward to rotate the cam 220 in a clockwise direction, and accordingly, the stopper member 240 moves inside the case to release the locking of the auto-winding module 14. As the locking is released, the retractable rotating plate is rotated in the other direction by the restoring force to automatically wind the wire.

Thereafter, when the user releases the button, the button member 230 moves outward by the restoring force of the resilient springs 252 and 254. Accordingly, the cam 220 is rotated in a counter-clockwise direction to push the stopper rack 240 outward again, and the head portion of the stopper member 240 is caught by the catching protrusion of the brake sawtooth 16a to lock the rotation of the auto-winding module 14.

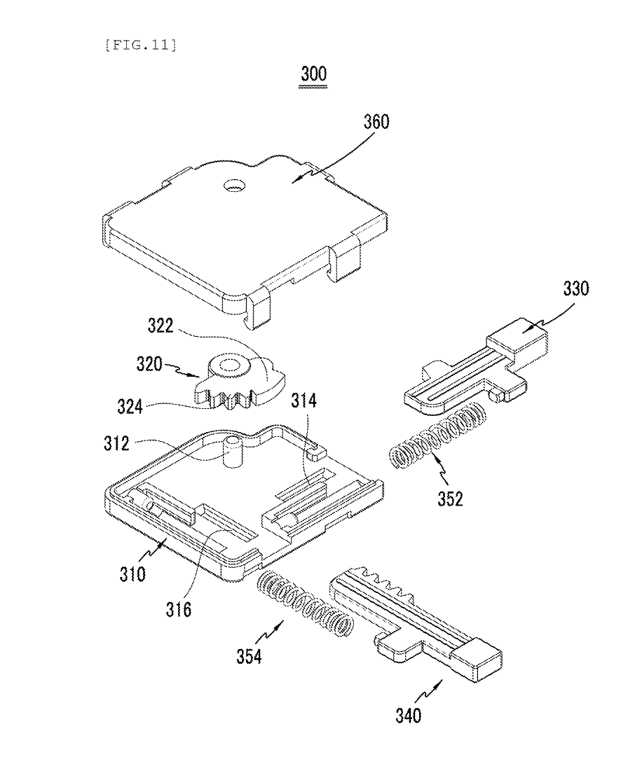

FIG. 10 is a view illustrating a locking module according to a third embodiment of the present invention, and FIG. 11 is an exploded perspective view illustrating a component of the locking module in FIG. 10.

As illustrated in FIGS. 10 and 11, a locking module 300 according to the third embodiment of the present invention includes a bottom case 310, a rotating piece 320, a button member 330, a stopper member 340, resilient springs 352 and 354, and a top case 360.

Referring to FIGS. 10 and 11, a coupling projection 312 serving as a rotational shaft of the rotating piece 320, a guide hole 314 for accommodating the button member 330, and a guide hole 314 for accommodating the stopper member 340 are formed a bottom case 310. The top case 360 and the bottom case 310 are coupled to each other to define a component accommodation space therebetween.

The rotating piece 320 including the cam portion 322 without a tooth and a pinion portion 324 in which a tooth is formed is inserted to a coupling projection 312 of the bottom case and coupled to the button member 330. Although the cam portion 322 is coupled to the button member 330, and the pinion portion 324 is coupled to the stopper member 340 in an embodiment of the present invention, alternatively, the cam portion may be coupled to the stopper member 340, and the pinion portion may be coupled to the button member 330.

As a coupling portion for being coupled to the cam portion 322 is formed on one end of the button member 330, the bar-shaped button member 330 is slid in a first direction (vertical direction) according to button manipulation to rotate the rotating piece 320. As the stopper member 340 serves as a rack having a tooth formed on one end thereof, the stopper member 340 is slid in a second direction (left and right direction) according to the rotation of the pinion portion 324 and caught by the catching protrusion of the brake sawtooth 16a to control the rotation of the auto-winding module 14.

Also, the resilient springs 252 and 254 for providing a restoring force are coupled to the button member 330 or the stopper member 340 to return the same to an original position when the button member 130 is released after a push manipulation.

As the button member 330 and the stopper member 340 are in a protruding state by the resilient force of the springs 352 and 354 when the button is released, the locking module 300 having the above-described configuration according to the third embodiment of the present invention maintains a locking state in which a head portion of the stopper member 340 is caught by the catching protrusion of the brake sawtooth 16a to prevent the rotation of the auto-winding module 14.

When the user pushes the button to release the locking, the button member 330 moves inward to rotate the rotating piece 320 in a clockwise direction, and accordingly, the stopper member 340 moves inside the case to release the locking of the auto-winding module 14. As the locking is released, the retractable rotating plate is rotated by the restoring force to automatically wind the wire.

Thereafter, when the user releases the button, the button member 330 moves outward by the restoring force of the resilient spring 352. Accordingly, the rotating piece 320 is rotated in a counter-clockwise direction to push the stopper member 340 outward again, and a head portion of the stopper member 340 is caught by a catching protrusion of the brake sawtooth 16a to lock the rotation of the auto-winding module 14.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A locking module of a wire auto-winding device, comprising:
a first case on which a coupling projection is formed;
a rotating piece inserted to the coupling projection of the first case and rotated in a clockwise or counter-clockwise direction;
a button member coupled to the rotating piece to rotate the rotating piece while slid in a first direction according to button manipulation;
a stopper member coupled to the rotating piece and slid in a second direction according to the rotation of the rotating piece;
a resilient spring pushing one of the button member or the stopper member in an opposite direction to return the same to an original position; and
a second case coupled to the first case to define a component accommodation space therebetween.

2. A locking module of a wire auto-winding device, comprising:
a first case on which a coupling projection is formed;
a pinion inserted to the coupling projection of the first case;
a button member having a tooth formed on one end thereof to serve as a rack coupled to the pinion and slid in a first direction according to button manipulation to rotate the pinion;
a stopper member having a tooth formed on one end thereof to serve as a rack coupled to the pinion and slid in a second direction according to the rotation of he pinion;
a resilient spring pushing one of the button member or the stopper member in an opposite direction to return the same to an original position; and
a second case coupled to the first case to define a component accommodation space therebetween.

3. A locking module of a wire auto-winding device, comprising:
a first case on which a coupling projection is formed;
a cam inserted to the coupling projection of the first case;
a button member coupled to the cam to rotate the cam while slid in a first direction according to button manipulation;
a stopper member coupled to the cam and slid in a second direction according to the rotation of the cam;
a resilient spring pushing one of the button member or the stopper member in an opposite direction to return the same to an original position; and
a second case coupled to the first case to define a component accommodation space therebetween.

4. A locking module of a wire auto-winding device, comprising:
a first case on which a coupling projection is formed;
a rotating piece inserted to the coupling projection of the first case and on which a cam and a pinion are formed;
a button member coupled to the cam or the pinion of the rotating piece to rotate the rotating piece while slid in a first direction according to button manipulation;
a stopper member coupled to the cam or the pinion of the rotating piece and slid in a second direction according to the rotation of the rotating piece;
a resilient spring pushing one of the button member or the stopper member in an opposite direction to return the same to an original position; and
a second case coupled to the first case to define a component accommodation space therebetween.

5. The locking module of claim 1, wherein the resilient spring comprises: a first resilient spring pushing the button member in the opposite direction to return the same to the original position; and a second resilient spring pushing the stopper member in the opposite direction to return the same to the original position.

6. The locking module of claim 1, wherein the first direction and the second direction cross each other.

7. The locking module of claim 1, wherein a guide hole for accommodating the button member and a guide hole for accommodating the stopper member are defined in one of the first case or the second case to have a rail coupling structure for preventing the bottom member and the stopper member from being escaped.

8. A wire auto-winding device comprising:
a housing:
an auto-winding module accommodated in one side of the housing to unwind a wire wound around a retractable rotating plate when the wire is pulled, maintain a current length of the wire by being automatically locked when the wire is released, and automatically wind the wire when the locking is released;
a locking plate rotated together with the auto-winding module; and
a locking module communicated with the locking plate to allow rotation of the auto-winding module in one direction, lock the rotation thereof in the other direction, and allow the rotation thereof in the other direction when a release button is inputted,
wherein the locking module comprises:
a first case on which a coupling projection is formed;
a rotating piece inserted to the coupling projection of the first case and rotated in a clockwise or counter-clockwise direction;
a button member coupled to the orating piece to rotate the rotating piece while slid in a first direction according to button manipulation;
a stopper member coupled to the rotating piece and slid in a second direction according to the rotation of the rotating piece;
a resilient spring pushing one of the button member or the stopper member in an opposite direction to return the same to an original position; and
a second case coupled to the first case to define a component accommodation space therebetween.

9. The locking module of claim 2, wherein the resilient spring comprises: a first resilient spring pushing the button member in the opposite direction to return the same to the original position; and a second resilient spring pushing the stopper member in the opposite direction to return the same to the original position.

10. The locking module of claim 2, wherein the first direction and the second direction cross each other.

11. The locking module of claim 2, wherein a guide hole for accommodating the button member and a guide hole for accommodating the stopper member are defined in one of the first case or the second case to have a rail coupling structure for preventing the bottom member and the stopper member from being escaped.

12. The locking module of claim 3, wherein the resilient spring comprises: a first resilient spring pushing the button member in the opposite direction to return the same to the original position; and a second resilient spring pushing the stopper member in the opposite direction to return the same to the original position.

13. The locking module of claim 3, wherein the first direction and the second direction cross each other.

14. The locking module of claim 3, wherein a guide hole for accommodating the button member and a guide hole for accommodating the stopper member are defined in one of the first case or the second case to have a rail coupling structure for preventing the bottom member and the stopper member from being escaped.

15. The locking module of claim 4, wherein the resilient spring comprises: a first resilient spring pushing the button member in the opposite direction to return the same to the original position; and a second resilient spring pushing the stopper member in the opposite direction to return the same to the original position.

16. The locking module of claim 4, wherein the first direction and the second direction cross each other.

17. The locking module of claim 4, wherein a guide hole for accommodating the button member and a guide hole for accommodating the stopper member are defined in one of the first case or the second case to have a rail coupling structure for preventing the bottom member and the stopper member from being escaped.
